(19) United States
(12) Patent Application Publication
(10) Pub. No.: US 2008/0078118 A1
(43) Pub. Date: Apr. 3, 2008

(54) Master gardener baskets and methods for growing plants

(75) Inventors: W. Michael Bissonnette, Boulder, CO (US); Robert E. Wainwright, Napanee (CA); Sylvia Bernstein, Boulder, CO (US)

Correspondence Address: Laura L. Conley;Suite 200, 6075 Longbow Drive, Boulder, CO, 80301, US

(73) Assignee: AeroGrow International, Inc., Boulder, CO (US)

(21) Appl. No.: 11/895,972

(22) Filed: Aug. 28, 2007

Related U.S. Application Data
(63) Continuation-in-part of application No. 11/112,269, filed on Apr. 22, 2005.
(63) Continuation-in-part of application No. 11/098,176, filed on Apr. 4, 2005.
Application No. 11/098,176 is a division of application No. 10/528,110, filed on Jul. 15, 2005.
Application No. 11/098,176 is a continuation-in-part of application No. 10/714,786, filed on Nov. 17, 2003.

(51) Int. Cl. A01G 31/00; A01G 9/02

(52) U.S. Cl. 47/63; 47/65.5

(57) ABSTRACT

This invention provides baskets for growing plants and methods for growing plants using those baskets. The baskets for supporting a plant or a seed that will germinate into a plant, and optionally a growing medium for contacting the seed or plant include at least two basket sections and a means for reversibly connecting at least two of the basket sections wherein the sections can be separated and the plant can be removed from the basket while causing no substantial damage to the plant. Seed cartridges with such baskets, growing media, and seeds or plants are also provided. The methods for growing a plant include separating the basket sections and removing the plant from the separated basket sections while causing no substantial damage to the plant.

### CROSS-REFERENCE TO RELATED APPLICATIONS

This application is a Continuation-in-Part of U.S. application Ser. No. 11/112,269, filed 22 Apr., 2005, and is a Continuation-in-Part of U.S. application Ser. No. 11/098,176, filed on Apr. 4, 2005, which is a Divisional of U.S. application Ser. No. 10/528,110, filed Mar. 16, 2005, and is a Continuation-in-Part to of U.S. application Ser. No. 10/714,786, filed Nov. 17, 2003, and claims priority to U.S. Provisional Application Ser. No. 60/840,575, filed Aug. 28, 2006, all of which are incorporated herein by reference to the extent that there is no inconsistency with the present disclosure.

### FIELD OF THE INVENTION

This invention is in the fields of plant agriculture, home gardening, net baskets, transplanting, and hydroponics.

### BACKGROUND

Hydroponics is the cultivation of plants without soil. Hydroponics provides healthier, disease-free plants, faster than growing in soil. In soil-less culture, plants are instead cultivated using a liquid solution of water and nutrients. There are 6 basic types of hydroponic systems: Wick, Raft (also called Water Culture), Ebb and Flow (also called Flood & Drain), Drip, Nutrient Film Technique, and Aeroponic. There are hundreds of variations on these basic types of systems, and most hydroponics systems can be described as a variation or combination of these six types.

Sometimes plants are grown from seed to maturity in hydroponics systems, but alternatively, plants can be germinated outside of the systems and transplanted into the systems or germinated and grown partially in the systems and then transplanted out, either to alternative systems or to soil.

Plants in hydroponics systems are often grown in baskets that support the plants in the hydroponics systems as well as provide openings for roots and shoots to grow out. Transplanting plants in and out of hydroponics systems requires a means for doing so without harming or minimally damaging the plants. Often this is complicated due to the enormous growth of roots that occurs within a hydroponics system. Baskets known in the art come in complex shapes that make it impossible to insert a growing plant or remove a growing plant without much labor or damage to the plant.

Often it is necessary to remove the basket from a partially grown plant because the basket is too small and might limit the size to which the mature plant can grow. Alternatively, it may be desirable to remove the basket because it is made of a material, such as plastic, that is undesirable in the transplanting location, such as in the soil.

There is a need in the art for a master gardener basket that is useful for growing plants in hydroponic systems, that allows the plants to be easily transplanted in and out of the hydroponics systems without causing substantial damage to the plants.

### SUMMARY OF THE INVENTION

An exemplary embodiment of the invention provides a basket for supporting a plant or a seed that will germinate into a plant, the basket comprising: a first basket section, a second basket section, a connector, a support structure for the plant or seed, at least a first opening for one or more roots of the plant, and at least a second opening for one or more shoots of the plant, wherein the connector is adapted to reversibly connect the first and second basket sections, wherein the plant or seed can grow, wherein one or more roots is allowed to exit the basket through the first opening, wherein one or more shoots of the plant are allowed to exit the basket through the second opening, and wherein the two sections are adapted to be separated and the plant removed from the basket while causing no substantial damage to the plant.

In an embodiment, the basket is also for supporting a growing medium which supports the plant or seed. In an embodiment, the basket further comprises a second support structure for supporting the basket in a gardening or hydroponic device. In an embodiment, the basket is plastic and made by injection molding. In an embodiment, the reversibly connectible basket sections are reusable. In an embodiment, the basket further comprises a second support structure adapted to reversibly mount the basket to an aeroponic or hydroponic device.

An exemplary embodiment of the invention provides a method for growing a plant comprising: providing a basket comprising reversibly connectible sections of this invention, providing a plant or a seed, placing the plant or seed in the basket, providing light, nutrients, oxygen, carbon dioxide, and water to the plant or seed, and allowing the plant to grow including allowing at least one shoot to grow through the first opening and at least one root to grow through the second opening. In an embodiment, the method further comprises: separating at least two of the sections of the basket, and removing the plant from the separated basket sections while causing no substantial damage to the plant.

An exemplary embodiment of the invention provides a basket for supporting a plant or a seed that will germinate into a plant, the basket comprising: two about identical about lateral basket sections, first and second female connectors and first and second male connectors on the lateral edges of each of the basket sections, a second support structure for supporting the basket in a gardening or hydroponic device, an about horizontal support structure at about the bottom of the basket for a growing medium for supporting the plant or seed, a second about horizontal support structure at about the top of the basket for reversibly mounting the basket to an aeroponic or hydroponic device, at least a first opening for one or more roots of the plant, and at least a second opening for one or more shoots of the plant, wherein the connectors are adapted to reversibly connect the first and second basket sections, wherein the basket is plastic and made by injection molding, wherein the basket sections are reusable, wherein the plant or seed can grow, wherein one or more roots is allowed to exit the basket through the first opening, wherein one or more shoots of the plant are allowed to exit the basket through the second opening, and wherein the two sections are adapted to be separated and the plant removed from the basket while causing no substantial damage to the plant.

An exemplary embodiment of the invention provides a cartridge for growing a plant or germinating a seed into a plant, the cartridge comprising: a basket of reversibly connectible sections of this invention, a growing medium, and a plant or seed, wherein the basket is adapted to support the growing medium and the growing medium is adapted to support the seed or plant.

### BRIEF DESCRIPTION OF THE DRAWINGS

FIG. 1A is a perspective view illustration showing the interior and exterior of a basket of this invention, with two halves connected. FIG. 1B is a perspective view illustration showing a basket of this invention with a growing medium and seeds.

FIG. 2 is a top view illustration showing the interior of a basket of this invention, with two halves apart.

FIG. 3A is a perspective view illustration showing the interior of a basket section with a mortise/tenon reversible connecting means. FIG. 3B is a perspective view illustration showing the interior of a basket section of this invention that has been disconnected from the other section, with a growing medium and a substantially undamaged plant.

FIG. 4 is a top view illustration showing the interior of a basket of this invention, with two halves apart.

FIG. 5 is a perspective view illustration showing the interior of a basket section with a male/female reversible connecting means.

FIG. 6 is a perspective view illustration showing the interior of a basket section showing the central axis.

FIG. 7 is a perspective view illustration showing two separated basket sections.

FIG. 8 is a perspective view illustration showing the interior and exterior of a basket of this invention, with two halves reversibly connected.

FIG. 9 is a perspective view illustration showing a basket made of 5 sections that are reversibly connected with clips.

FIG. 10A is a perspective view illustration showing 2 identical basket sections that are reversibly connectible with 4 male/female connectors. FIG. 10B is a perspective view illustration showing these 2 identical basket sections reversibly connected.

FIG. 11 is a side view illustration of the basket shown in FIG. 10B.

FIG. 12A is a top view illustration of the basket sections shown in FIG. 10A. FIG. 12B is a top view of a cartridge of the basket in FIG. 10B with a growing medium and two seeds.

FIG. 13A is a perspective view illustration showing one of the basket sections in FIG. 10A. FIG. 13B is an inside side view of the basket section shown in FIG. 13A. FIG. 13C is a side view of the basket section shown in FIG. 13A. FIG. 13D is a top view of the basket section shown in FIG. 13A.

### DETAILED DESCRIPTION OF THE INVENTION

As used herein, “hydroponic” refers to plant growing techniques that do not use soil. As used herein, “optimal growth” refers to plant growth that is optimized to achieve a selected set of characteristics, e.g., fruit harvest, root harvest, leaf harvest, flower production and/or size, and longevity.

As used in the art and as used herein, “nutrients” refers to atoms and molecules in an available form necessary for plant growth in addition to oxygen, hydrogen, and water including calcium, magnesium, sodium, potassium, nitrogen, phosphorus, sulfur, chlorine, iron, manganese, copper; zinc, boron, and molybdenum. Nutrient formulations and recipes are known in the art (see, for example, Resh H. M (2001) Hydroponic Food Production, Sixth Addition, Woodbridge Press Publishing Company, Santa Barbara, Calif., USA). It is known in the art that a liquid that contacts a plant, e.g., liquid used to supply nutrients to a plant, is preferably within a particular pH range. Optimal pH ranges for a variety of plants are known in the art.

As used herein, “light” refers to wavelengths of light or light of sufficient quantity and quality that allow a plant to grow, as is known in the art. It is known in the art which quantities and wavelengths of light are preferred for many plants. Natural and artificial light are useful in the practice of this invention.

As used herein, “oxygen, carbon dioxide, and water” refers to an appropriate quantity and quality of oxygen, carbon dioxide, and water as is needed to allow a plant or seed to grow.

The term “growing a plant” as used in herein refers to the process which takes place when appropriate conditions such as water, light, gas containing oxygen and carbon dioxide, and nutrients are provided to a plant tissue, whether a seed, a cutting, transplant, bulb, tuber, runner, or a plant having roots, resulting in an increase in the mass of plant tissue.

The term “germinating a seed into a plant” as used herein refers to the process which takers place when appropriate conditions such as water, light, gas containing oxygen and carbon dioxide are provided to the seed, resulting in the emergence of a plant embryo from the seed.

The term “growth medium” as used herein refers to any material which permits the growth of plant material or the germination of a seed to take place. Examples of growing media useful in the practice of this invention include: horticultural foam, hydrophilic cellular substrates, synthetic polymers, soil-less growing media, and mixtures of peat, bark, and/or polymer. Soil-less media for growing plants are generally composed of materials that have moderate water-retention characteristics, allowing liquid nutrient solution to flow readily to plant roots and then to drain away so that roots are not constantly soaked in a liquid that may foster rot or the growth of damaging fungi. Soil-less media may be composed of any number of suitable porous substances such as peat moss, wood bark, cellulose, pumice, plastic or polystyrene pellets, vermiculite or foam, for example.

As used herein, “no substantial damage to a plant” refers to no damage that substantially decreases the volume, rate of growth, or health of the plant.

As used herein, “means for reversibly connecting” refers to a way to connect two items in a way that they can be disconnected without causing substantial damage to objects between the two items, such as a plant, and optionally without causing substantial damage to the two items.

The components illustrated in the drawings are numbered as shown in Table 1.

TABLE 1

| Item | Number |
|---|---|
| 1 | basket |
| 2 | plant |
| 3 | seed |
| 4 | growing medium |
| 5 | basket section |
| 6 | means for reversibly connecting |
| 7 | means for supporting plant or seed or growing medium |
| 8 | first opening for one or more roots |
| 9 | second opening for one or more shoots |
| 10 | basket section arc edge |
| 11 | about radial about longitudinal axis |
| 12 | about horizontal section for support |
| 13 | about bottom of basket |
| 14 | means for supporting basket in a gardening or hydroponic device |
| 15 | mortise/tenon reversibly connecting means |
| 16 | male reversible connector |
| 17 | female reversible connector |
| 18 | root |
| 19 | shoot |
| 20 | central axis |
| 21 | clip |
| 22 | cartridge |

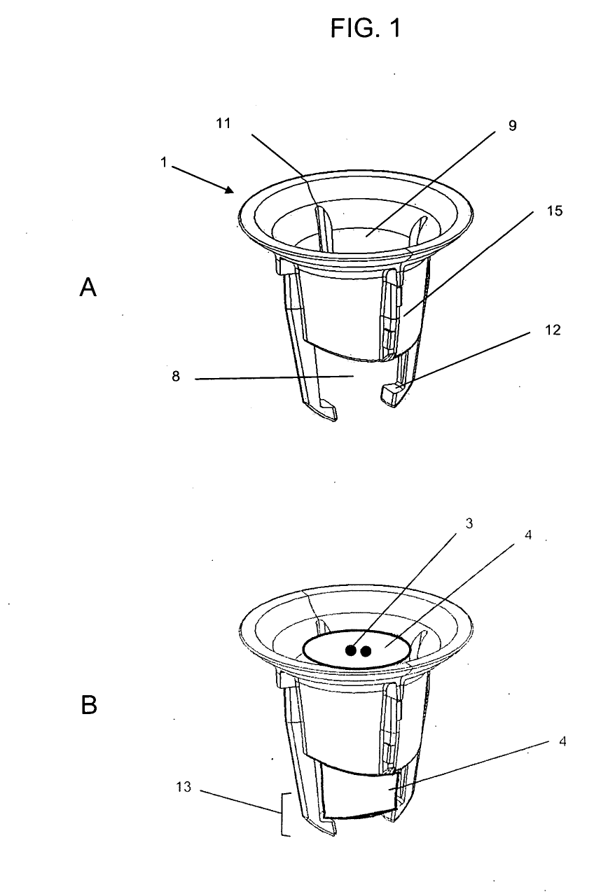

FIG. 1A shows a basket 1 of this invention with two sections that are reversibly connected with a tenon/groove connection means 15. The first opening for one or more roots 8 and the second opening for one or more shoots 9 are labeled. The about horizontal support section 12 comprises two tabs towards the about bottom of the basket. The two basket sections connect at about a radial longitudinal axis 11. FIG. 1B shows the basket in FIG. 1A with a growing medium 4 and seeds 3. The growing medium 4 is supported by the bottom of the basket 13.

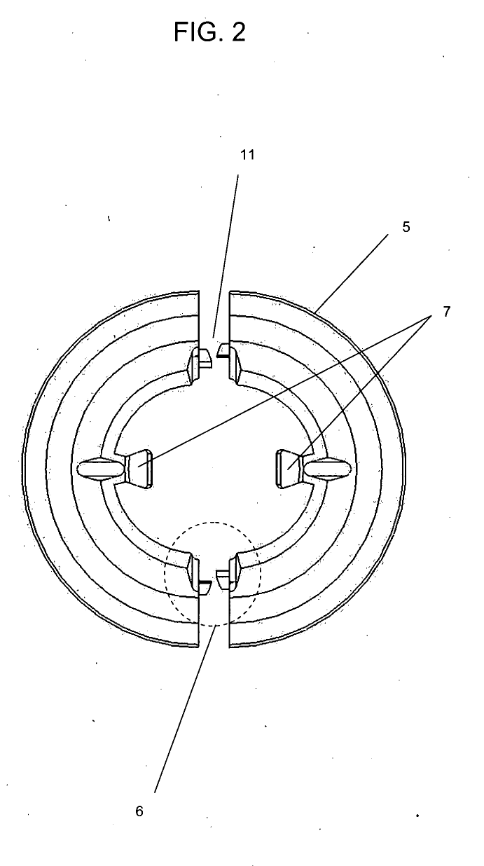

FIG. 2 shows two about identical basket sections 5. The means for reversibly connecting 6 is along the about radial longitudinal axis 11. The means for supporting the growing medium 7 are tabs protruding into the first opening.

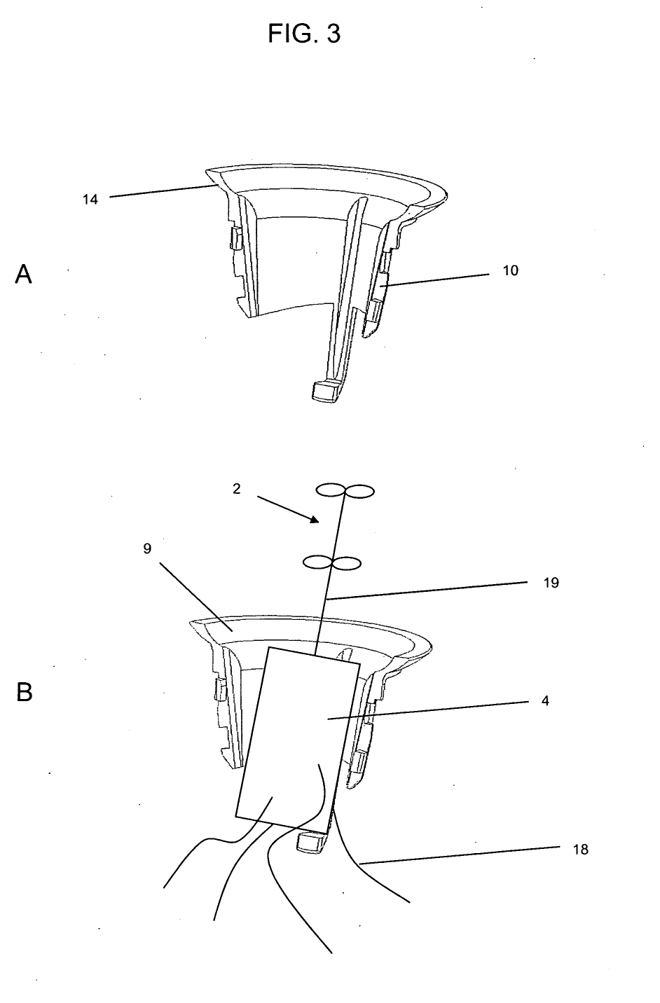

FIG. 3A shows one basket section, the protruding rim that functions as a means for supporting the basket in a gardening device 14. This basket section has a mortise/tenon connecting means on the basket section arc edge 10. FIG. 3B shows the basket section in FIG. 3A with a growing medium 4 with a plant 2 shoot 19 exiting the basket at the second opening 9 and roots 18.

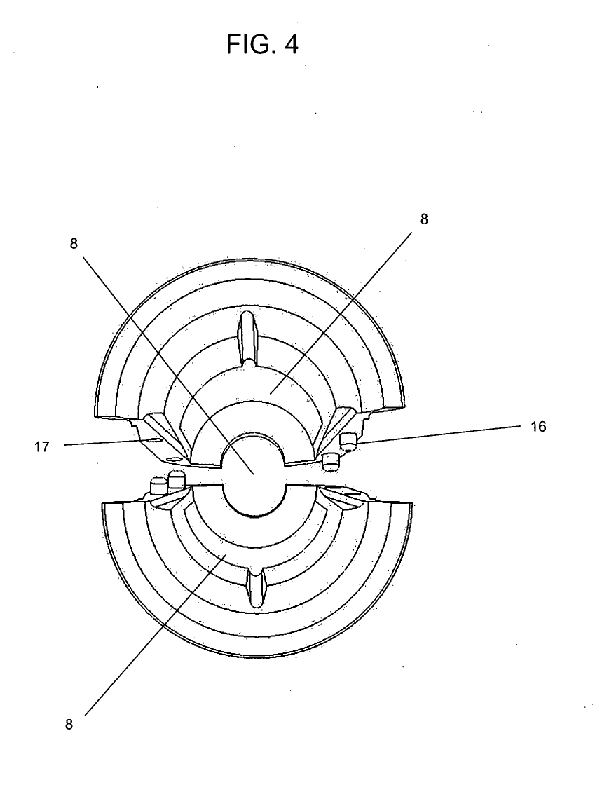

FIG. 4 shows two about identical disconnected basket sections with a male 16 female 17 means for reversibly connecting. Three first openings for roots 8 are visible.

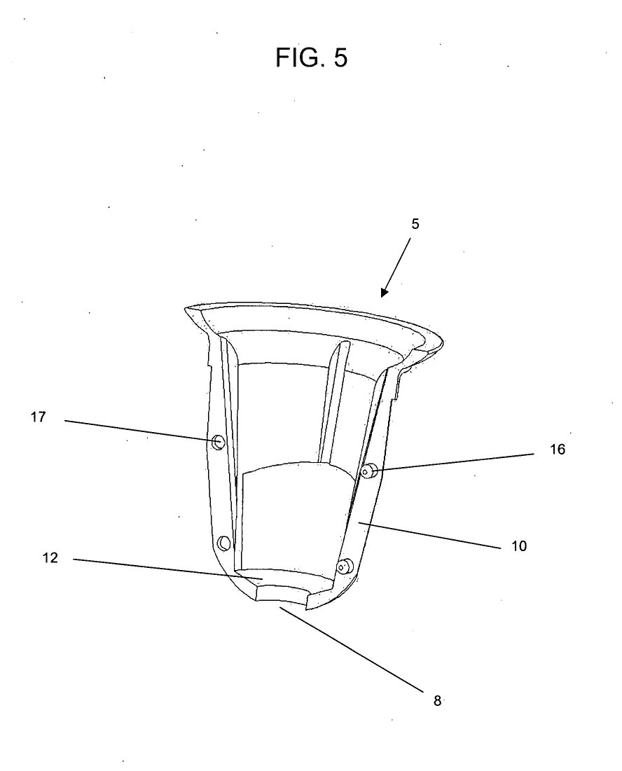

FIG. 5 shows one section 5 of the basket in FIG. 4. The male 16 female 17 reversible connecting means is along the basket section arc edge 10. The central first opening 8 is defined by the about horizontal section for support 12.

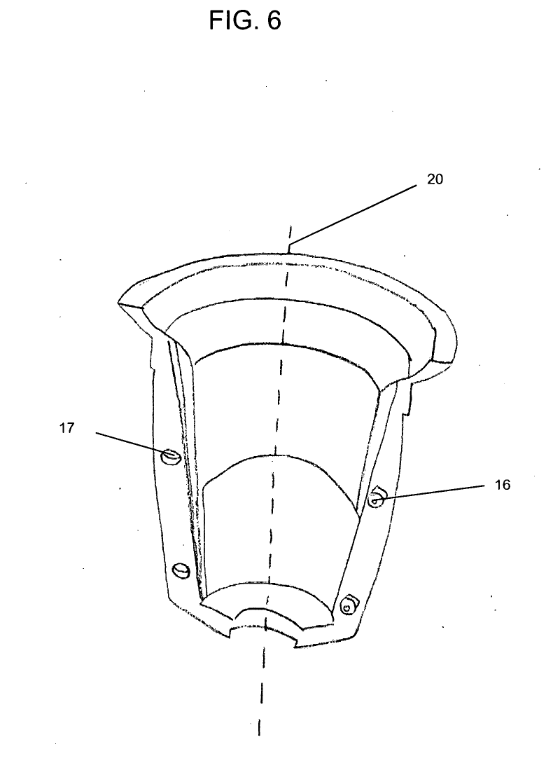

FIG. 6 shows a section of a basket of this invention. The male 16 and female 17 components of the reversible connecting means are shown, as well as the central axis 20 of the basket.

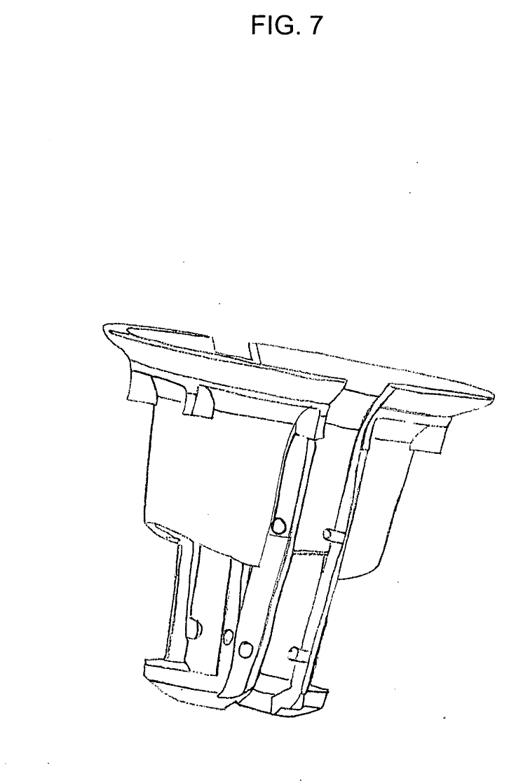

FIG. 7 shows the basket section in FIG. 6 and the mated pair section.

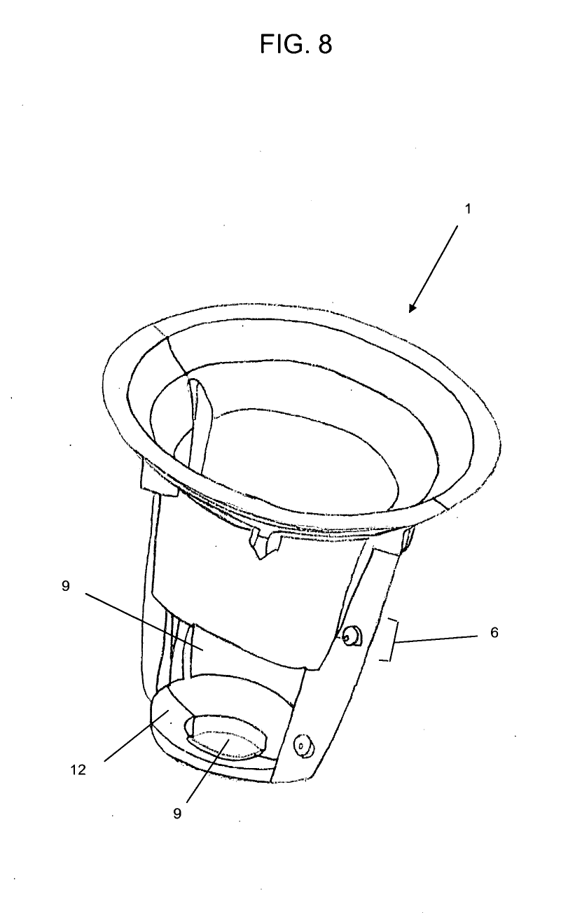

FIG. 8 shows a basket 1 of this invention with both sections that were shown apart in FIG. 7, connected by the means for reversibly connecting 6. The about horizontal section for support 12 is surrounded by two second openings for one or more roots 9.

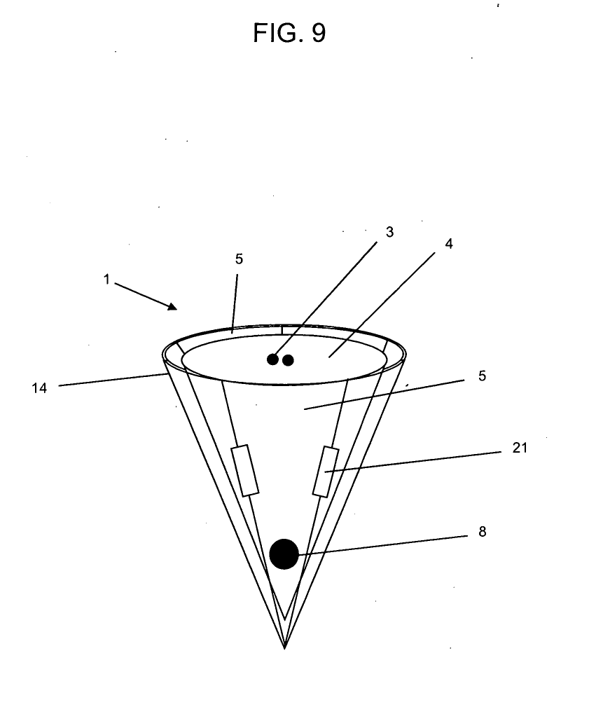

FIG. 9 shows a cone-shaped basket 1 of this invention, made from five basket sections 5. The seeds 3 will germinate, the roots will grow down into the growing medium 4 and out of the first openings 8. The inner surface of the basket 1 has a horizontal component that functions as the means for supporting the plant, seed, and growing medium. The upper part of the basket is wider than the lower part of the basket, and therefore the upper part functions as the means for supporting the basket in a gardening device or hydroponic device 14.

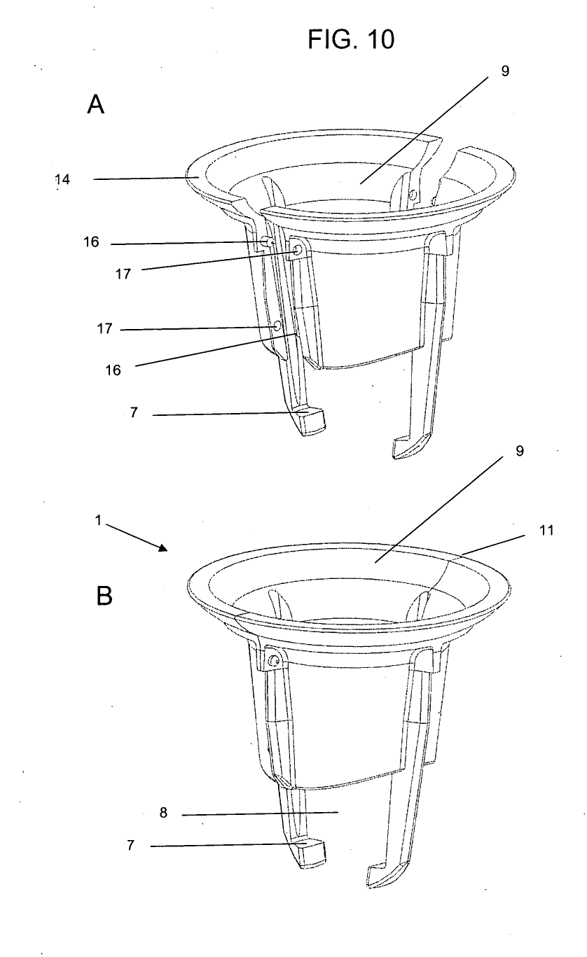

FIG. 10A shows two identical basket sections of this invention that are reversibly connected with four male 16 and four female connectors 17, two of which are labeled. The rim 14 is a means for supporting the basket in a gardening or hydroponic device such as an aeroponic or hydroponic garden. For example, the rim 14 can support the basket in an aperture or well within an aeroponic or hydroponic garden. Other structures and/or geometric configurations known in the art can alternatively be used to support the basket in an aeroponic or hydroponic garden, such as cooperating threads, cam-locks, etc. The about horizontal support section is a means for supporting a growing medium 7 and comprises two tabs towards about the bottom of the basket. FIG. 10B shows these section reversibly connected with male/female connectors into a basket 1 of this invention. The first opening for one or more roots 8 and the second opening for one or more shoots 9 are labeled. The about horizontal support section is a means for supporting a growing medium 7 and comprises two tabs towards about the bottom of the basket. The two basket sections connect at about a radial longitudinal axis 11.

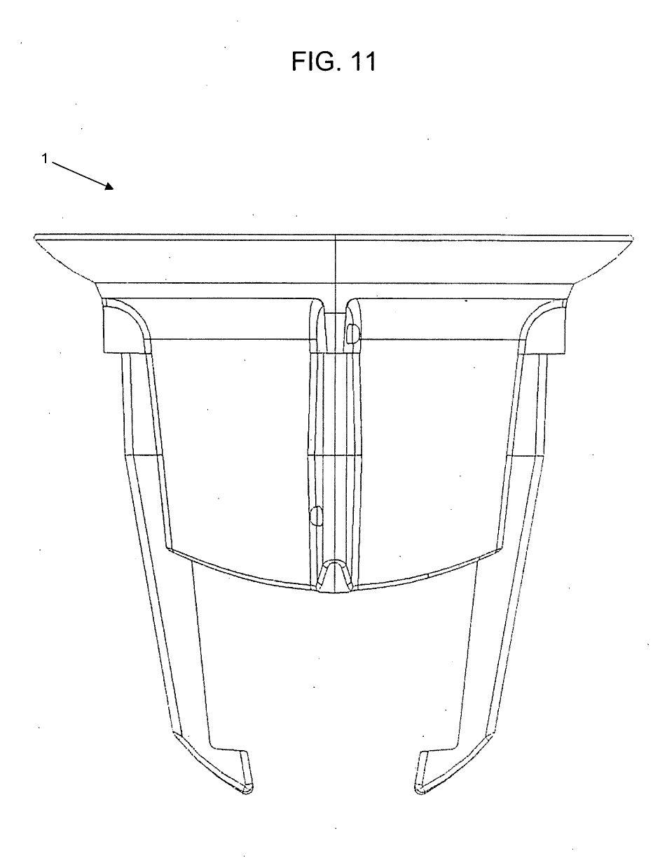

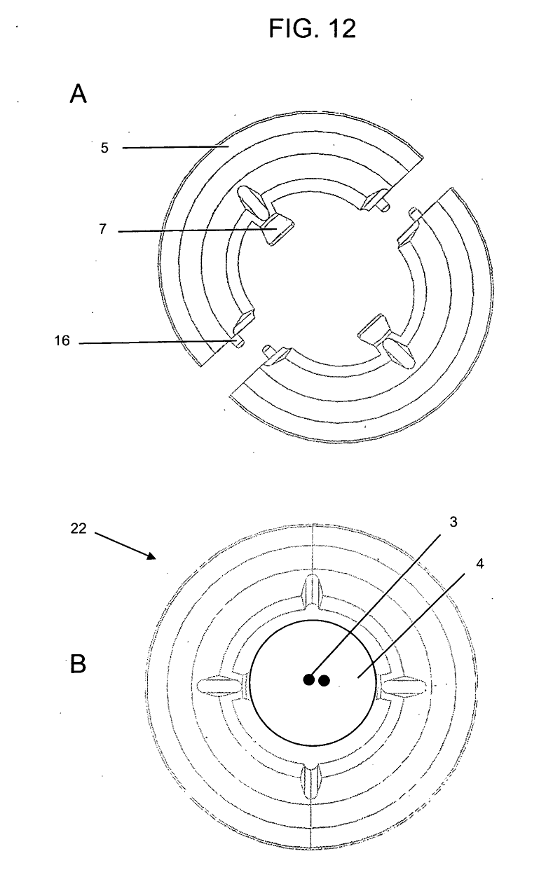

FIG. 11 shows a side view of the basket 1 shown in FIG. 10B. FIG. 12A shows a top view of the basket shown in FIG. 10B with one section 4, the about horizontal tab means for supporting the plant or seed or growing medium 7, and a male reversible connector 16 labeled. FIG. 12B shows a cartridge 22 of the basket of FIG. 10B from the top with a growing medium 4 and two seeds 3.

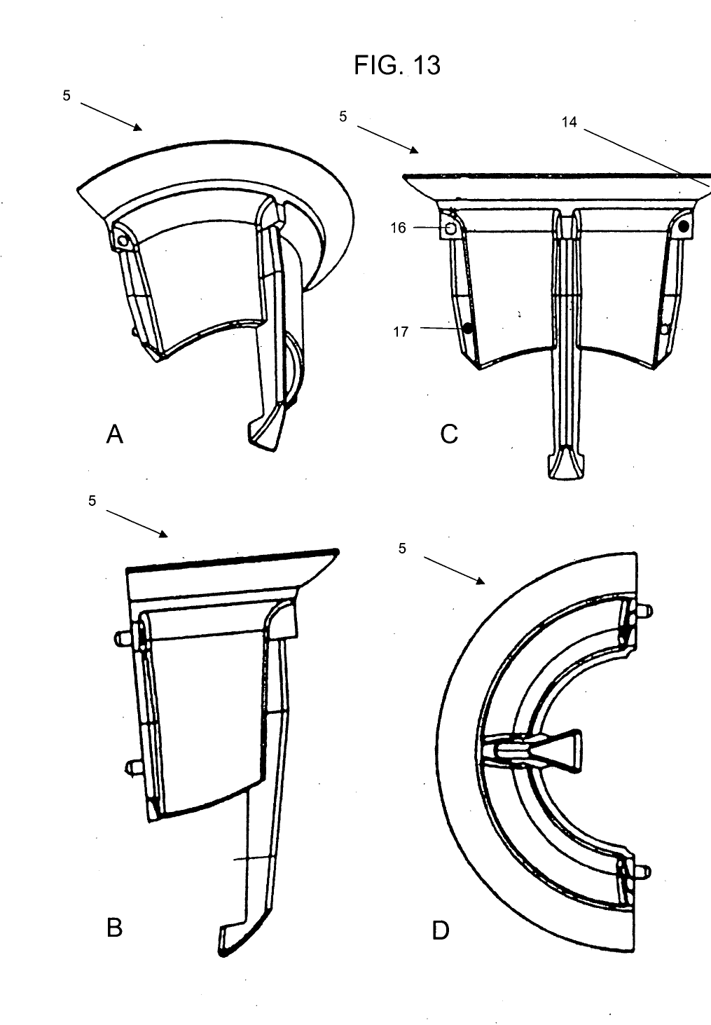

FIG. 13A shows one of the identical basket sections 5. FIG. 13B shows this section 5 from the side with male 16 and female 17 connectors labeled. The rim is a means for supporting the connected basket section in a gardening or hydroponic device, similar to the rim 14 described above in connection with FIG. 10A. FIG. 13C shows a side view of the section 5. FIG. 13 shows a top view of the section 5.

An exemplary embodiment of the invention provides a basket for supporting a plant or a seed that will germinate into a plant, said basket comprising: a first basket section including a first connector, a second basket section, including a second connector, a support structure for said plant or seed, at least a first opening for one or more roots of said plant, and at least a second opening for one or more shoots of said plant, wherein said first and second connectors are adapted to reversibly connect said first and second basket sections, wherein said plant or seed can grow, wherein one or more roots is allowed to exit said basket through said first opening, wherein one or more shoots of said plant are allowed to exit said basket through said second opening, and wherein said two sections are adapted to be separated and said plant removed from said basket.

An exemplary embodiment of the invention provides a basket for supporting a plant or a seed that will germinate into a plant, the basket comprising: a first basket section, a second basket section, a connector, a support structure for the plant or seed, at least a first opening for one or more roots of the plant, and at least a second opening for one or more shoots of the plant, wherein the connector is adapted to reversibly connect the first and second basket sections, wherein the plant or seed can grow, wherein one or more roots is allowed to exit the basket through the first opening, wherein one or more shoots of the plant are allowed to exit the basket through the second opening, and wherein the two sections are adapted to be separated and the plant removed from the basket while causing no substantial damage to the plant.

In an embodiment, the basket is also for supporting a growing medium which supports the plant or seed. In an embodiment, the basket comprises three or more sections, each section comprising a connector component. Connector components can work individually to connect two parts or they may function in cooperation with another connector component. All connection means known in the art are useful in the practice of this invention, provided they support the functions of the baskets of this invention. In an embodiment, each basket section is about a lateral section. In an embodiment, the basket sections are about identical. In an embodiment, the sections connect to each other along arc or lateral edges. In an embodiment, the sections are divided along about radial about longitudinal axes. In an embodiment, the basket is about radially symmetric. In an embodiment, the support structure for the plant or seed is an about horizontal section at about the bottom of the basket. In an embodiment, the basket further comprises a second support structure for supporting the basket in a gardening or hydroponic device. In an embodiment, the connector is a clip or an adhesive. In an embodiment, the basket connector comprises a first connector part on the first basket section and a second connector part on the second basket section and wherein the first and second connectors are adapted to cooperate with a mortise/tenon or male/female mechanism. In an embodiment, the basket is plastic and made by injection molding. In an embodiment, the reversibly connectible basket sections are reusable. In an embodiment, the basket further comprises a second support structure adapted to reversibly mount the basket to an aeroponic or hydroponic device.

An exemplary embodiment of the invention provides a method for growing a plant comprising: providing a basket comprising reversibly connectible sections of this invention, providing a plant or a seed, placing the plant or seed in the basket, providing light, nutrients, oxygen, carbon dioxide, and water to the plant or seed, and allowing the plant to grow including allowing at least one shoot to grow through the first opening and at least one root to grow through the second opening. In an embodiment, the method further comprises: separating at least two of the sections of the basket, and removing the plant from the separated basket sections while causing no substantial damage to the plant. In an embodiment, enough sections of the basket are disconnected to create at least about a 180 degree opening through which to remove the plant.

An exemplary embodiment of the invention provides a method for growing a plant comprising: providing a basket for supporting a plant, the basket comprising: at least two basket sections, a connector adapted to reversibly connect at least two of the basket sections, a support structure adapted to support the plant or a seed that will germinate into a plant, at least a first opening for one or more roots of the plant, and at least a second opening for one or more shoots of the plant, connecting the basket sections, providing a plant or a seed, providing a growing medium, placing the growing medium in the basket, placing the plant or seed in contact with the growing medium, providing a hydroponics device, water, nutrients, carbon dioxide, and oxygen, delivering light, nutrients, oxygen, carbon dioxide, and water to the growing medium or the plant or seed, using the hydroponic device, allowing the plant to grow including allowing at least one shoot to grow through the first opening and at least one root to grow through the second opening, disconnecting at least two of the basket sections, and removing the growing medium and the plant from the unconnected basket sections while causing no substantial damage to the plant.

An exemplary embodiment of the invention provides a basket for supporting a plant or a seed that will germinate into a plant, the basket comprising: two about identical about lateral basket sections, first and second female connectors and first and second male connectors on the lateral edges of each of the basket sections, an about horizontal support structure at about the bottom of the basket for a growing medium for supporting the plant or seed, a second support structure for supporting the basket in a gardening or hydroponic device or a second about horizontal support structure at about the top of the basket for reversibly mounting the basket to an aeroponic or hydroponic device, at least a first opening for one or more roots of the plant, and at least a second opening for one or more shoots of the plant, wherein the connectors are adapted to reversibly connect the first and second basket sections, wherein the basket is plastic and made by injection molding, wherein the basket sections are reusable, wherein the plant or seed can grow, wherein one or more roots is allowed to exit the basket through the first opening, wherein one or more shoots of the plant are allowed to exit the basket through the second opening, and wherein the two sections are adapted to be separated and the plant removed from the basket while causing no substantial damage to the plant.

An exemplary embodiment of the invention provides a cartridge for growing a plant or germinating a seed into a plant, the cartridge comprising: a basket of reversibly connectible sections of this invention, a growing medium, and a plant or seed, wherein the basket is adapted to support the growing medium and the growing medium is adapted to support the seed or plant.

An exemplary embodiment of the invention provides a basket for supporting a plant, a seed that will germinate into a plant, and optionally a growing medium for contacting the seed or plant, the basket comprising: at least two basket sections, a means for reversibly connecting at least two of the at least two basket sections, means for supporting the plant, at least a first opening for one or more roots of the plant, and at least a second opening for one or more shoots of the plant, wherein the plant or seed can grow wherein one or more roots and one or more shoots of the plant are allowed to exit the basket through each of the openings, and wherein the at least two sections can be separated and the plant can be removed from the basket while causing no substantial damage to the plant.

In an embodiment, the basket consists of two sections. In an embodiment, the basket comprises three or more sections. In an embodiment, the basket comprises four or more sections or five or more sections. The number of sections is determined by aesthetics, ease of the user, the shapes of the sections, the reversible connecting means, etc. Fewer first root openings may be preferable because it may be easier to remove the plant. In an embodiment, the basket sections are about identical. In an embodiment, the basket sections connect to each other along the arc edges. An arc edge is visible in FIG. 3A. In an embodiment, the basket sections are divided along about radial about longitudinal axes. In an embodiment, the basket is about radially symmetric. In an embodiment, the basket means for supporting the plant is an about horizontal section at about the bottom of the basket. In an embodiment, the basket further comprises a means for supporting the basket in a gardening or hydroponic device.

In an embodiment, the means for reversibly connecting is selected from the group consisting of: mortise/tenon, male/female, clips, adhesive materials, any other means known in the art, and any means as yet to be discovered. In an embodiment, the basket comprises plastic. In an embodiment, the basket section can be made by injection molding. In an embodiment, the basket is reusable.

This invention provides a method for growing a plant comprising: providing a basket of this invention, providing a plant or a seed, placing the plant or seed in the basket, providing light, nutrients, oxygen, carbon dioxide, and water to the plant or seed, allowing the plant to grow including allowing at least one shoot to grow through the first opening and at least one root to grow through the second opening, separating at least two of the sections of the basket, and removing the plant from the separated basket sections while causing no substantial damage to the plant.

An exemplary embodiment of the invention provides a method for growing a plant comprising: providing a basket for supporting a plant, a seed that will germinate into a plant, and optionally a growing medium for contacting the seed or plant, the basket comprising: at least two basket sections, a means for reversibly connecting at least two of the at least two basket sections, means for supporting the plant, at least a first opening for one or more roots of the plant, and at least a second opening for one or more shoots of the plant, providing a plant or a seed, placing the plant or seed in the basket, providing light, nutrients, oxygen, carbon dioxide, and water to the plant or seed, allowing the plant to grow including allowing at least one shoot to grow through the first opening and at least one root to grow through the second opening, separating at least two of the basket sections, and removing the plant from the separated basket sections while causing no substantial damage to the plant.

An exemplary embodiment of the invention provides a method for growing a plant comprising: providing a basket for supporting a plant, said basket comprising: at least two basket sections, a connector located on each basket section, the connectors adapted to reversibly connect the at least two basket sections, a support structure adapted to support said plant, at least a first opening for one or more roots of said plant, and at least a second opening for one or more shoots of said plant, connecting said basket sections, providing a seed that will germinate into a plant, providing a growing medium for contacting said seed or plant, placing said growing medium in said basket, placing said plant or seed in contact with said growing medium providing a hydroponics device, water, nutrients, carbon dioxide, and oxygen, delivering light, nutrients, oxygen, carbon dioxide, and water to said growing medium or said plant or seed, using said hydroponic device, allowing said plant to grow including allowing at least one shoot to grow through said first opening and at least one root to grow through said second opening, disconnecting at least two of said basket sections, and removing said growing medium and said plant from said disconnected basket sections while causing no substantial damage to said plant.

An exemplary embodiment of the invention provides a basket for supporting a plant or a seed that will germinate into a plant, said basket comprising: first and second about identical lateral basket sections, first and second female connectors, located on lateral edges of the first and second basket sections, respectively, and first and second male connectors located on the lateral edges of said first and second basket sections, respectively, an about horizontal support structure at about the bottom of said basket for supporting a growing medium for supporting said plant or seed, a second about horizontal support structure at about the top of said basket for reversibly mounting said basket to an aeroponic or hydroponic device, at least a first opening for one or more roots of said plant, and at least a second opening for one or more shoots of said plant, wherein said first and second female connectors and said first and second male connectors are adapted to reversibly connect said first and second basket sections, wherein said plant or seed can grow, wherein one or more roots is allowed to exit said basket through said first opening, wherein one or more shoots of said plant are allowed to exit said basket through said second opening, and wherein said two sections are adapted to be separated.

In an embodiment, the method further comprises: between the 2^{nd} and 3^{rd} steps providing a growing medium, and placing the growing medium in the basket, and in the previous third step, placing the plant or seed in contact with the growing medium. In an embodiment, the method further comprises, in the seventh step, removing the plant and the growing medium from the separated basket sections while causing no substantial damage to the plant. In an embodiment, the basket further comprises step eight, transplanting the plant into a gardening device or soil. In an embodiment, the method step four is performed using a hydroponics device. In an embodiment, the basket further comprises, between steps one and two, a step connecting the at least two basket sections. In an embodiment, the method further comprises step eight reconnecting the at least two basket sections, and step nine, repeating steps the first seven steps with the basket and a second seed or plant.

An exemplary embodiment of the invention provides a method for growing a plant comprising: providing a basket for supporting a plant and optionally a growing medium for contacting the plant, the basket comprising: at least two unconnected basket sections, a means for reversibly connecting at least two of the at least two basket sections, means for supporting the plant, at least a first opening for one or more roots of the plant, and at least a second opening for one or more shoots of the plant, providing a plant with at least one root and at least one shoot, placing the plant in the unconnected basket sections wherein the at least one shoot exits through the first opening and the at least one root exits through the second opening, without causing substantial damage to the plant, connecting the at least two basket sections, providing light, nutrients, oxygen, carbon dioxide, and water to the plant or seed, and allowing the plant to grow. In an embodiment, the seed or plant is in liquid contact with the growing medium.

The baskets of this invention are useful for practicing the methods of this invention. The baskets of this invention can be separated into sections of any size and the sections do not need to be about symmetrical. The points of contact between the sections can be along any axis, as long as the basket functions as necessary, as described herein.

In an embodiment, the gardening device is a hydroponics device. In an embodiment, the basket has a wide section at about the top, such as a rim, that is useful for supporting it in a gardening device, for example, in an aperture or well of an aeroponic or hydroponic gardening device. In an embodiment, an interior surface has an upward facing horizontal component that is useful for supporting a plant, seed, and/or growing medium. In an embodiment, the baskets nest together for compact storage.

In an embodiment, plants can be transplanted into or out of the baskets of this invention with no substantial damage to the plants. The sections that are reversibly connectible preferably connect and unconnect easily and moving the plant(s) into and out of the unconnected sections doesn't cause substantial damage to the plant(s).

In an embodiment, there is only one basket section and the basket is made of a flexible material that is reversibly connectible along one seam, whereby a plant can be inserted or removed with substantially no harm. In an embodiment, the means for connecting is a means for holding the basket section in close proximity, optionally by the device that is supporting the basket in a gardening device.

In an embodiment, there is one shoot opening and two root openings. In an embodiment, there is one shoot opening and two or more root openings. In an embodiment, there is one shoot opening and three or more root openings. In an embodiment, the basket is made of a material that can be easily cut away from the plant.

Preferably the baskets of this invention allow for optimal growth. In an embodiment, the reversibly connectible basket sections are reusable. In an embodiment, the baskets and basket segments of this invention are rigid or sturdily connectible using means not dependent on a gardening device so that the baskets may be easily handled when not in such a device.

Baskets useful in the practice of this invention can be radially symmetric or not. The parts can be reversibly connected in an orientation that makes a functional basket, and the point of connection can be the arc edge of an about radially symmetric basket segment. In an embodiment, the basket sections can be easily separated and the plant can be easily removed from the basket.

Materials that don't interfere with the growth of the plants or other functions of the baskets are useful in the practice of this invention. Useful plastics include ABS. A useful hydroponic garden and accessories can be found in PCT/US/2004/030168. Hydroponic gardens and accessories known in the art and not yet invented may also be useful in the practice of this invention.

This invention provides an aeroponic or hydroponic growing system comprising: an aeroponic or hydroponic garden including an aperture, and a seed cartridge comprising: a basket of reversibly connectable sections adapted to fit in the aperture, and either a growing medium located in the basket or at least one seed or plant, or both, wherein the seed or plant is in contact with the growing medium.

This invention provides a modular seed cartridge comprising: a basket of reversibly connectable sections adapted to fit in a hydroponic or aeroponic garden and either a growing medium or at least one seed or plant supported by the basket, or both.

In an embodiment, the rigid, cup-shaped frame comprises reversibly connectible basket segments. In an embodiment, the baskets and seed cartridges of this invention comprise reversibly connectable basket sections and other characteristics as described herein.

Many materials are useful for making baskets of this invention. Useful materials are optionally rigid and are useful for supporting the plant until the plant and/or growing medium is removed from the basket. Compostable, biodegradable, and photodegradable materials are also useful.

This invention provides kits for growing plants including basket components of this invention, growing media, seeds

Although this invention has been described with respect to specific embodiments, it is not intended to be limited thereto, and various modifications which will become apparent to the person of ordinary skill in the art are intended to fall within the scope of the invention as described herein, taken in conjunction with the accompanying drawings and the appended claims.

All references cited are incorporated herein by reference to the extent that they are not inconsistent with the disclosure herein.

1. A basket for supporting a plant or a seed that will germinate into a plant, said basket comprising:
a) a first basket section including a first connector;
b) a second basket section, including a second connector;
c) a support structure for said plant or seed;
d) at least a first opening for one or more roots of said plant; and
e) at least a second opening for one or more shoots of said plant;
wherein said first and second connectors are adapted to reversibly connect said first and second basket sections;
wherein said plant or seed can grow;
wherein one or more roots is allowed to exit said basket through said first opening;
wherein one or more shoots of said plant are allowed to exit said basket through said second opening; and
wherein said two sections are adapted to be separated and said plant removed from said basket.

2. The basket of claim 1 wherein said basket is also for supporting a growing medium which supports said plant or seed.

3. The basket of claim 1 wherein said basket comprises three or more sections wherein each section comprises a connector.

4. The basket of claim 1 wherein each basket section is about a lateral section.

5. The basket of claim 1 wherein said basket sections are about identical.

6. The basket of claim 1 wherein said sections connect to each other along arc or lateral edges.

7. The basket of claim 1 wherein said sections are divided along about radial about longitudinal axes.

8. The basket of claim 1 that is about radially symmetric.

9. The basket of claim 1 wherein said support structure for said plant or seed is an about horizontal section at about the bottom of said basket.

10. The basket of claim 1 that comprises ABS plastic and is made by injection molding.

11. The basket of claim 11 wherein said connector is a clip or an adhesive.

12. The basket of claim 1 wherein said first and second connectors are adapted to cooperate in a mortise/tenon or male/female mechanism.

13. The basket of claim 1 wherein said two sections are adapted to be separated and said plant removed from said basket while causing no substantial damage to said plant.

14. The basket of claim 1 wherein said reversibly connectible basket sections are reusable.

15. The basket of claim 1 further comprising a second support structure adapted to reversibly mount said basket to an aeroponic or hydroponic device.

16. A method for growing a plant comprising:
a) providing a basket of claim 1;
b) providing a plant or a seed;
c) placing said plant or seed in said basket;
d) providing light, nutrients, oxygen, carbon dioxide, and water to said plant or seed; and
e) allowing said plant to grow including allowing at least one shoot to grow through said first opening and at least one root to grow through said second opening.

17. The method of claim 16 further comprising:
a) separating at least two of the sections of said basket; and
b) removing said plant from said separated basket sections while causing no substantial damage to said plant.

18. A method for growing a plant comprising:
a) providing a basket for supporting a plant, said basket comprising:
1) at least two basket sections;
2) a connector located on each basket section, the connectors adapted to reversibly connect the at least two basket sections;
3) a support structure adapted to support said plant;
4) at least a first opening for one or more roots of said plant; and
5) at least a second opening for one or more shoots of said plant;
b) connecting said basket sections;
c) providing a seed that will germinate into a plant;
d) providing a growing medium for contacting said seed or plant;
e) placing said growing medium in said basket;
f) placing said plant or seed in contact with said growing medium
g) providing a hydroponics device, water, nutrients, carbon dioxide, and oxygen;
h) delivering light, nutrients, oxygen, carbon dioxide, and water to said growing medium or said plant or seed, using said hydroponic device;
i) allowing said plant to grow including allowing at least one shoot to grow through said first opening and at least one root to grow through said second opening;
j) disconnecting at least two of said basket sections; and
k) removing said growing medium and said plant from said disconnected basket sections while causing no substantial damage to said plant.

19. A basket for supporting a plant or a seed that will germinate into a plant, said basket comprising:
a) first and second about identical lateral basket sections;
b) first and second female connectors, located on lateral edges of the first and second basket sections, respectively, and first and second male connectors located on the lateral edges of said first and second basket sections, respectively;
c) an about horizontal support structure at about the bottom of said basket for supporting a growing medium for supporting said plant or seed;
d) a second about horizontal support structure at about the top of said basket for reversibly mounting said basket to an aeroponic or hydroponic device;
e) at least a first opening for one or more roots of said plant; and
f) at least a second opening for one or more shoots of said plant;
wherein said first and second female connectors and said first and second male connectors are adapted to reversibly connect said first and second basket sections;
wherein said plant or seed can grow;
wherein one or more roots is allowed to exit said basket through said first opening;
wherein one or more shoots of said plant are allowed to exit said basket through said second opening; and
wherein said two sections are adapted to be separated.

20. A cartridge for growing a plant or germinating a seed into a plant, said cartridge comprising:
a) a basket of claim 19;
b) a growing medium; and
c) a plant or seed;
wherein said basket is adapted to support said growing medium and wherein said growing medium is adapted to support said seed or plant.
